(19) United States
(12) Patent Application Publication
(10) Pub. No.: US 2025/0200370 A1
(43) Pub. Date: Jun. 19, 2025

(54) COMPUTING SYSTEM, LEARNING METHOD AND EDGE DEVICE

(71) Applicant: Hitachi, Ltd., Tokyo (JP)

(72) Inventor: Takahito TANIMURA, Tokyo (JP)

(21) Appl. No.: 18/836,037

(22) PCT Filed: Jan. 19, 2023
(86) PCT No.: PCT/JP2023/001486

§ 371 Date: Aug. 6, 2024

(30) Foreign Application Priority Data
Feb. 21, 2022 (JP) 2022-024877

(51) Int. Cl. G06N 3/082; G06N 3/098

(52) U.S. Cl. CPC G06N 3/082; G06N 3/098

(57) ABSTRACT

A computing system includes: an edge device which acquires data to be used for learning, and executes a learning process to generate a first model to be used for inference relating to a task using the data; and a server device which generates a second model using the first model generated by each of the plural edge devices, and transmits the second model to the plural edge devices. The edge device acquires communication state information relating to a communication state of a communication path between the edge device and the server device, calculates a parameter to be used for a reduction process to reduce a data size of a model based on the communication state information, executes the reduction process to the first model based on the parameter, and transmits the reduced first model to the server device.

### INCORPORATION BY REFERENCE

This application claims the benefit of foreign priority of Japanese Patent Application No. 2022-24877, filed on Feb. 21, 2022, which is incorporated by reference in its entirety.

### TECHNICAL FIELD

The present invention relates to a federated learning operation.

### BACKGROUND ART

A method for collecting data from multiple organizations, or multiple sites has been considered to attain collection of a huge amount of data required for learning a model to perform a task inference process. The data collection, however, has great difficulties from point of views of privacy protection of personal information and security.

The federated learning has been focused as the method for generating a general model without direct data collection. The federated learning is the learning method for generating the general model by learning models in the respective organizations or the respective sites, and aggregating and integrating multiple models.

### CITATION LIST

### Patent Literature

Patent Literature 1: Japanese Unexamined Patent Application Publication No. 2012-103879

### SUMMARY OF INVENTION

### Technical Problem

The federated learning is performed by transmission and reception of the model information between an edge device which learns the model, and a server which aggregates and integrates the models. The large-sized model information may cause the problem of making a communication zone between the edge device and the server strained. The technology as disclosed in Patent Literature 1 is known as the solution for the problem.

Patent Literature 1 discloses “a network coefficient compression device includes an inference unit and a learning unit. The inference unit outputs an output value of a hidden layer or an output layer of a neural network with respect to input data that have been input into an input layer of a learned neural network. The learning unit learns a network coefficient using an input data and an output value as teaching data while performing nonreversible compression of the network coefficient of the neural network so as to generate the compressed network coefficient”.

A prior art such as Patent Literature 1 has been designed without considering a communication state between the edge device and the server (for example, vacancy of the communication zone). Such the prior art may cause the problem of making the communication zone strained to prevent normal transmission and reception of the model.

The present invention provides a system, apparatus, and method for performing the federated learning incorporated with the model reduction process while considering the communication state between the edge device and the server.

### Solution to Problem

A representative example of the present invention as disclosed herein is described below. A computing system includes: an edge device which acquires data to be used for learning, and executes a learning process to generate a first model to be used for inference relating to a task using the data; and a server device which generates a second model using the first model generated by each of a plurality of edge devices, and transmits the second model to the plural edge devices. The edge device acquires communication state information relating to a communication state of a communication path between the edge device and the server device, calculates a first parameter to be used for a reduction process to reduce a data size of a model based on the communication state information, executes the reduction process to the generated first model based on the first parameter, and transmits the reduced first model to the server device.

### Advantageous Effects of Invention

According to the present invention, in a federated learning operation, the edge device reduces the model while considering the communication state between the edge device and the server to allow transmission of the model to the server. Other problems, configurations, and advantageous effects will be clarified by descriptions of embodiments as described below.

### BRIEF DESCRIPTION OF DRAWINGS

FIG. 1 illustrates an example of a computing system configuration according to a first embodiment.

FIG. 2 illustrates an example of a hardware configuration of an edge device according to the first embodiment.

FIG. 3A illustrates an example of a configuration of an inference unit according to the first embodiment.

FIG. 3B illustrates an example of a configuration of an inference unit according to the first embodiment.

FIG. 4 is a flowchart representing an example of a process to be executed in a federated learning operation by the edge device according to the first embodiment.

FIG. 5 is a flowchart representing an example of a process to be executed in the federated learning operation by a server device according to the first embodiment.

FIG. 6 is a flowchart representing an example of an inference process to be executed by the edge device according to the first embodiment.

FIG. 7 illustrates a modification of a functional configuration of the edge device.

FIG. 8 illustrates an example of a display screen displayed by a learning monitoring device according to the first embodiment.

### DESCRIPTION OF EMBODIMENTS

Embodiments of the present invention are described referring to the drawings. The present invention is to be interpreted without being limited to descriptions of embodiments to be described below. It is to be understood for a person skilled in the art that specific configurations of the present invention may be changed so long as such change does not deviate from the idea and spirit of the present invention.

In the following explanation with respect to the configuration of the present invention, the same or similar configurations or functions are followed by the same reference signs, and overlapped description is omitted.

Such ordinal numbers as “first”, “second”, and “third” in the specification are used for distinguishment among components, and are not necessarily limited to the specific number or the specific order.

Each position, size, shape, and range of the respective configurations in the drawings is expressed for easy understanding of the present invention, and accordingly, the resultant configuration may fail to reflect each position, size, shape, and range of the actual configuration. The present invention, thus, cannot be limited to the position, size, shape, range and the like as disclosed in the drawings.

### First Embodiment

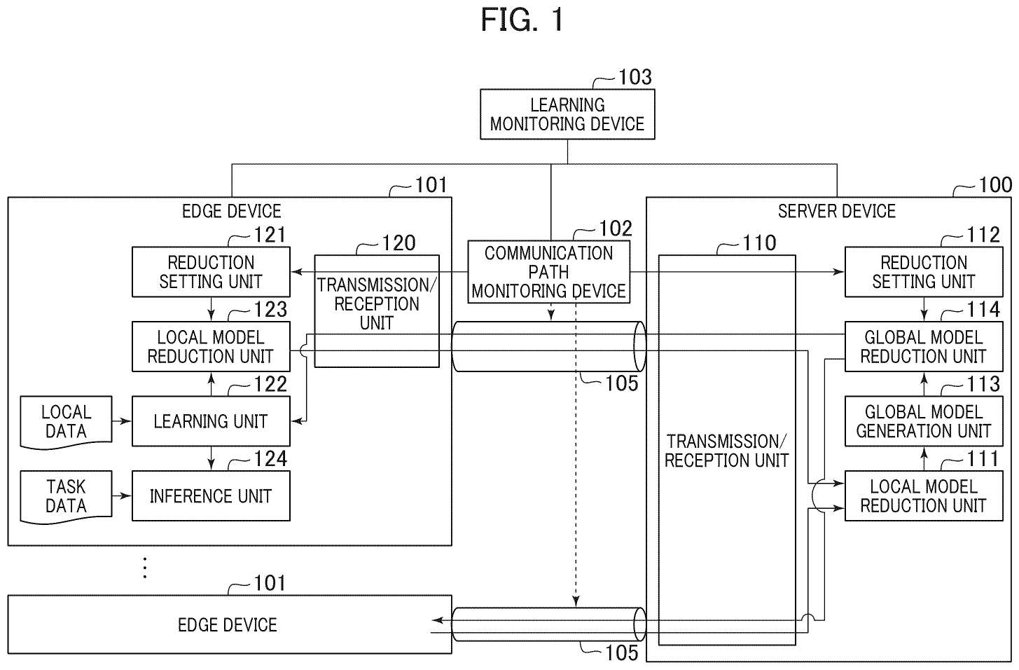

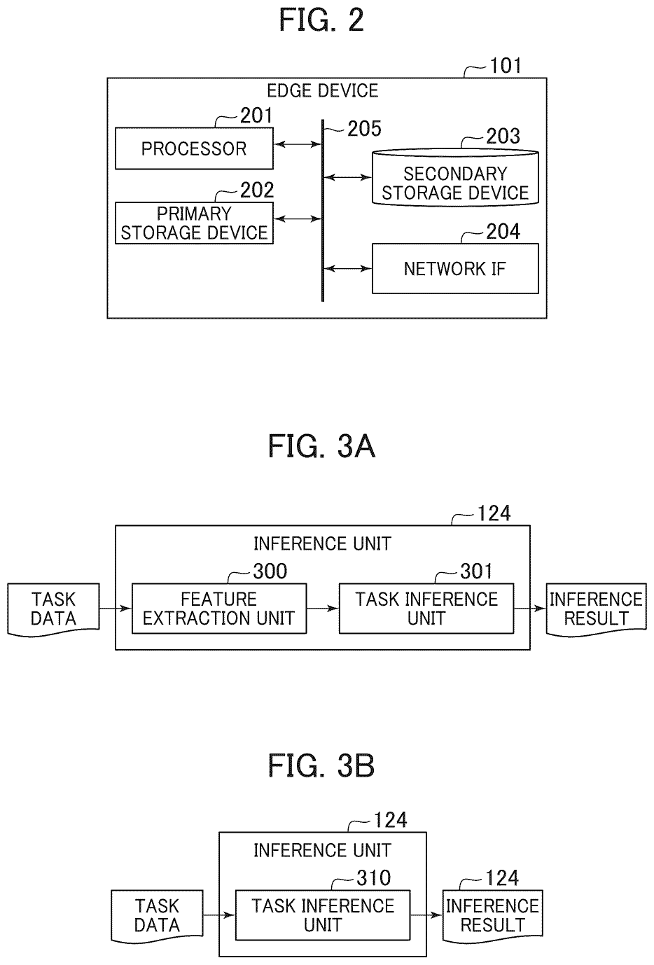

FIG. 1 illustrates an example of a computing system configuration according to a first embodiment. FIG. 2 illustrates an example of a hardware configuration of an edge device of the first embodiment.

The computing system includes a server device 100, a plurality of edge devices 101, a communication path monitoring device 102, and a learning monitoring device 103. The server device 100 and the edge device 101 are mutually communicated via a communication path 105. The communication path monitoring device 102 is connected to the server device 100 and the edge device 101 via the communication path 105 or a not shown network. The learning monitoring device 103 is connected to the server device 100, the plural edge devices 101, and the communication path monitoring device 102 via the communication path 105 or a not shown network.

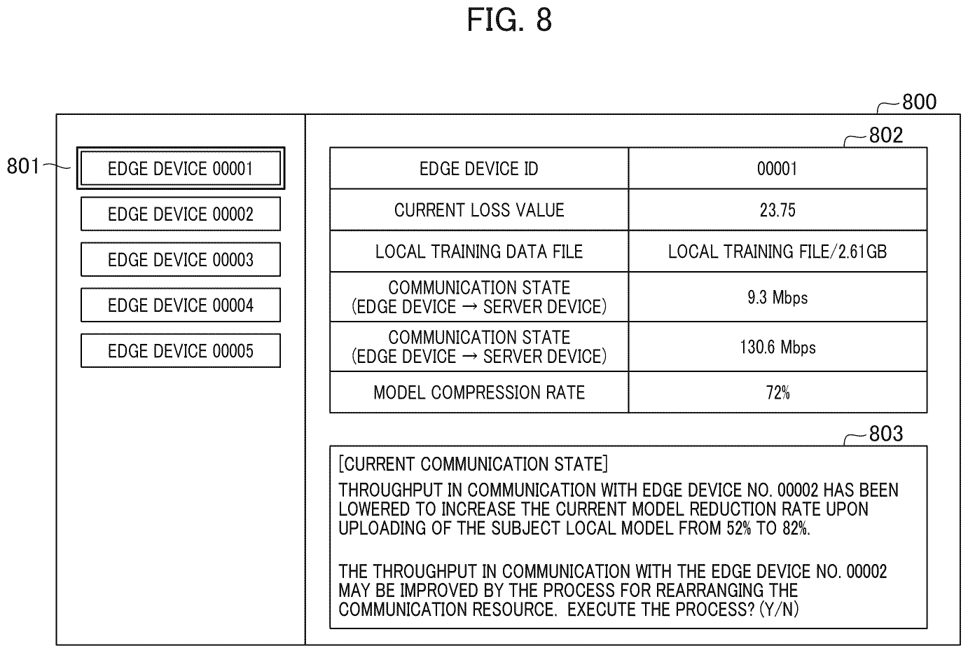

The learning monitoring device 103 monitors each parameter setting and each status of the server device 100, the plural edge devices 101, and the communication path monitoring device 102. The learning monitoring device 103 displays the monitoring result via a screen 800 as illustrated in FIG. 8. The screen 800 includes an edge device selection field 801, a monitoring result display field 802, and a message field 803. The edge device selection field 801 is a field for selecting the edge device 101 to make reference to the monitoring result. This field displays an icon indicating the edge device 101 to be monitored by the learning monitoring device 103. The monitoring result display field 802 is a field for displaying the monitoring result (parameter setting and status) of the edge device 101 selected through the edge device selection field 801. The message field 803 is a field for displaying a message indicating a condition of the computing system.

The server device 100 and the plural edge devices 101 are configured to perform a federated learning operation. Upon the federated learning, the edge device 101 performs collection of local data, model learning using the local data, and transmission of the local model to the server device 100. The server device 100 performs generation of a global model using the local model, and transmission of the global model to the edge device 101.

The communication path monitoring device 102 monitors a communication state of the communication path 105. The communication state of the communication path 105 is expressed by the communication latency, throughput, usage rate of communication resource of the radio frequency band, and probability distribution of those values. The communication state may vary over time.

The edge device 101 is a computing machine with hardware configuration as illustrated in FIG. 2, and includes a processor 201, primary storage device 202, secondary storage device 203, and network interface 204. The respective hardware elements are mutually connected via an internal bus 205.

The processor 201 executes the program stored in the primary storage device 202. The processor 201 serves as a function unit (module) for implementing the specific function by executing the process according to the program. For example, the processor 201 may be a CPU (Central Processing Unit), a GPU (Graphics Processing Unit), an FPGA (Field-Programmable Gate Array), an ASIC (Application Specific Integrated Circuit), etc. The following explanation in which the function unit executes the process while serving as the subject indicates that the processor 201 executes the program for implementing the function unit.

The primary storage device 202 may be formed as a DRAM (Dynamic Random Access Memory), for example, for storing the program executed by the processor 201, and data to be used by the program. The primary storage device 202 may also be used as the work area.

The secondary storage device 203 may be an HDD (Hard Disk Drive) and an SSD (Solid State Drive) for persistent data storage. The program and data to be stored in the primary storage device 202 may be stored in the secondary storage device 203. In this case, the processor 201 reads the program and information from the secondary storage device 203, and loads the data into the primary storage device 202.

The network interface 204 is configured to be connected to an external device via the network.

The hardware configuration of the edge device 101 is shown as a typical example in a nonrestrictive manner. The edge device may be provided with such input device as a keyboard, mouse, and touch panel, and provided with such output device as a display and printer. The edge device 101 may be formed as a program in the server device 100 for virtual implementation.

An explanation of each hardware configuration of the server device 100 and the communication path monitoring device 102 is omitted since such configuration is the same as that of the edge device 101.

The server device 100 is composed of function constituents including a transmission/reception unit 110, a local model reduction unit 111, a reduction setting unit 112, a global model generation unit 113, and a global model reduction unit 114.

The transmission/reception unit 110 controls transmission and reception of data between the server device 100 and the external device. The local model reduction unit 111 reduces the local model received from the edge device 101. The reduction setting unit 112 sets a parameter which determines the reduction degree of the local model based on the communication state of the communication path 105. The parameter is set for each of the edge devices 101. The global model generation unit 113 generates a global model using the local models received from the plural edge devices 101. The global model reduction unit 114 reduces the global model generated by the global model generation unit 113 based on the parameter set by the reduction setting unit 112, and transmits the reduced global model to the edge device 101. The global model is reduced for each of the edge devices 101.

The server device 100 may be configured to include the local model reduction unit 111 for each of the edge devices 101.

The edge device 101 is composed of function constituents including a transmission/reception unit 120, a reduction setting unit 121, a learning unit 122, a local model reduction unit 123, and an inference unit 124.

The transmission/reception unit 120 controls transmission and reception of data between the edge device 101 and the external device. The reduction setting unit 121 sets a parameter which determines the reduction degree of the local model based on the communication state of the communication path 105. The learning unit 122 executes the learning process using the local data. Based on the parameter set by the reduction setting unit 121, the local model reduction unit 123 reduces the local model generated by the learning unit 122, and transmits the reduced local model to the server device 100. The inference unit 124 performs inference of a task using the global model received from the server device 100, and task data.

The inference unit 124 may be variously configured. FIGS. 3A and 3B illustrate an example of a configuration of an inference unit 124 according to the first embodiment.

The inference unit 124 as shown in FIG. 3A includes a feature extraction unit 300 and a task inference unit 301. The feature extraction unit 300 extracts a feature value from the task data. The task inference unit 301 performs inference of the task using the feature value, and outputs an inference result. The inference unit 124 as shown in FIG. 3A requires a model (feature extraction model) to be used by the feature extraction unit 300, and a model (task inference model) to be used by the task inference unit 301. In this case, those two models, or either model may be treated as the local model to be used for the federated learning. In the case of the inference unit 124 configured as shown in FIG. 3A, the learning unit 122 may be divided into multiple sections for generating the respective models.

The inference unit 124 as shown in FIG. 3B includes a task inference unit 310. The task inference unit 310 performs inference of the task using the task data, and outputs an inference result. The inference unit 124 as shown in FIG. 3B requires the model (task inference model) to be used by the task inference unit 310. In this case, such model is treated as the local model.

As for the respective function units of the server device 100, multiple function units may be integrated into a single function unit, or a single function unit may be divided into multiple function units. As for the respective function units of the edge device 101, multiple function units may be integrated into a single function unit, or a single function unit may be divided into multiple function units.

The federated learning according to the embodiment is described in detail. The federated learning is performed according to the process steps as below.

(1) The edge device 101 executes the learning process using local data to generate a model. The local data may be acquired from the equipment and sensors, which are connected to the edge device 101, or from a simulator, and the like. The edge device 101 may be formed as a program in the server device 100 for virtual implementation. The edge device 101 may be formed by combining multiple configurations as described above. (2) The edge device 101 transmits the model as the local model, which is used for the federated learning among generated models to the server device 100. (3) The server device 100 generates the global model using multiple local models, and transmits the global model to each of the edge devices 101. (4) The edge device 101 sets the global model to an initial local model, and executes the learning process again. Hereafter, the process steps from (2) to (4) are repeatedly executed.

The federated learning process to be executed by the edge devices 101 and the server device 100 is described in detail.

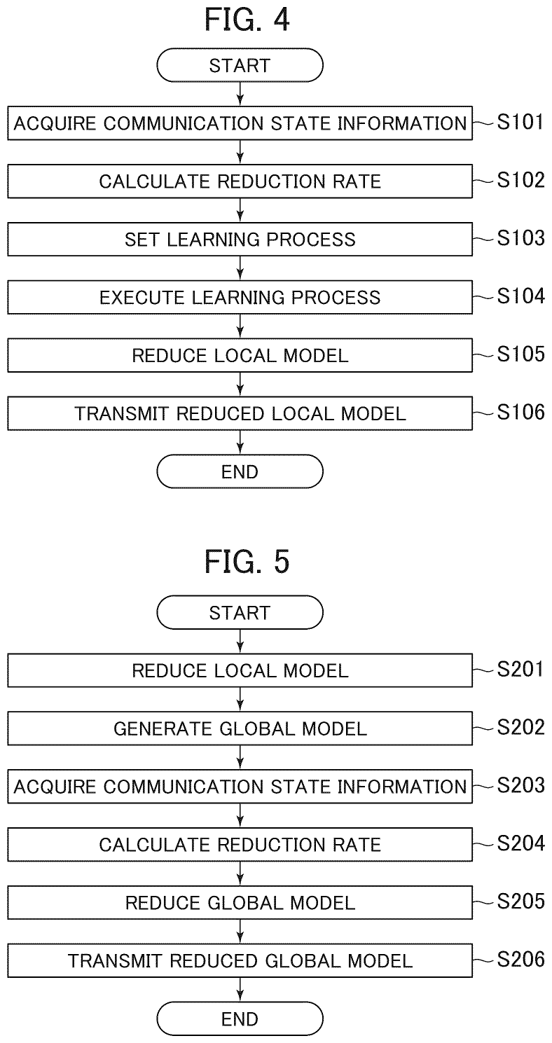

FIG. 4 is a flowchart representing an example of a process to be executed in the federated learning operation by the edge device 101 according to the first example.

The edge device 101 acquires communication state information from the communication path monitoring device 102 (step S101).

The reduction setting unit 121 of the edge device 101 calculates the reduction rate based on each communication state information (step S102).

For example, the reduction setting unit 121 manages the condition of a period of time required for the local model transfer to calculate the reduction rate based on the condition, communication throughput, and communication latency. The reduction setting unit 121 calculates a parameter for reducing the model based on the reduction rate. The parameter may be a threshold value, for example. Parameters relating to the reduction rate and the model reduction rate may be updated in accordance with the communication state information which varies over time.

The learning unit 122 of the edge device 101 sets the learning process (step S103). Specifically, the learning unit 122 sets an initial model, and various parameters to be used for the learning process. In this case, the initial model may only be the initial local model, or include the initial local model and other models. If the global model is received from the server device 100, the global model may be set as the initial local model.

The learning unit 122 conducts settings for facilitating an operation which makes the model sparse. For example, the L1 regularization term or L2 regularization term is added to the loss function. It is also possible to add the regularization term to impose a penalty if the absolute value of the weight is equal to or smaller than the threshold value.

The learning unit 122 of the edge device 101 executes the learning process (step S104). A detailed explanation of the learning process is omitted because of the known technique. The model to be generated by executing the learning process may be a neural network, for example.

The inference unit 124 configured as illustrated in FIG. 3A generates a feature extraction model and a task inference model. The feature extraction model may be generated using the contrastive learning, for example, an auto encoder, VAE (Variational AutoEncoder), VQ-VAE (Vector Quantised-Variational AutoEncoder), and SimCLR (Simple framework for Contrastive Learning of visual Representations), BYOL (Bootstrap Your Own Latent), and the like.

If the feature extraction model is only the federated learning target, the learning unit 122 learns only the feature extraction model until the learning of the feature extraction model is finished. The task inference model may be learned using the feature extraction model and the learning data after finishing the federated learning of the feature extraction model.

The local model reduction unit 123 of the edge device 101 reduces the local model generated by the learning process based on the parameter calculated by the reduction setting unit 121 (step S105). For example, the following reduction methods are considered.

(Reduction method 1) The local model reduction unit 123 acquires weight information of the model. The local model reduction unit 123 replaces the weight having its absolute value equal to or smaller than the threshold value with zero.

(Reduction method 2) The local model reduction unit 123 acquires weight information of the model. The weights are sorted in the order of the large absolute value. The local model reduction unit 123 replaces the predetermined number of weights with zero in the order of the small absolute value so that the ratio of the number of weights each having the non-zero value to the total number of weights.

The data size of the model can be reduced by increasing the number of weights each having the value of zero.

The local model reduction unit 123 of the edge device 101 transmits the reduced local model to the server device 100 (step S106).

FIG. 5 is a flowchart representing an example of a process to be executed in the federated learning operation by the server device 100 according to the first example.

The local model reduction unit 111 of the server device 100 reduces the local model received from the edge device 101 (step S201). It is supposed to preliminarily set the parameter to be used for reduction. If the local models have not been received from all the edge devices 101, the server device 100 is brought into a stand-by state without proceeding to step S201.

If the local models have been received from all the edge devices 101, the global model generation unit 113 of the server device 100 generates the global model using the multiple local models (step S202). For example, the global model generation unit 113 calculates a weight using the following formula (1).

$$\begin{matrix}( Numeral 1 ) & \\ {w}_{global} = {a}_{1} avg ( {w}_{1} , … , {w}_{N} ) + {a}_{2} mode ( {w}_{1} , … , {w}_{N} ) + {a}_{3} max ( {w}_{1} , … , {w}_{N} ) & ( 1 )\end{matrix}$$

In the formula, the term wᵢ denotes weight information (weight vector) of the local model received from the i-th edge device 101, and each term of a₁, a₂, a₃ denotes a coefficient. The term i denotes a natural number ranging from 1 to N. The mode function is defined to output the mode, and the max function is defined to output the maximum value.

The formula (1) is used for calculating the weight of the global model in consideration of the mode and the maximum value of the weight.

The server device 100 acquires each communication state information of the communication paths 105 (step S203).

The reduction setting unit 112 of the server device 100 calculates the reduction rate based on each communication state information of the respective communication paths 105 (step S204).

The reduction setting unit 112 manages conditions of the time required to transfer the global model, and calculates each reduction rate of the respective edge devices 101 based on the conditions and each throughput of the respective communication paths 105. The reduction setting unit 121 calculates a parameter for reducing the model based on the reduction rate. The parameter may be a threshold value, for example.

The global model reduction unit 114 of the server device 100 reduces the global model based on each parameter of the edge devices 101 (step S205). The model reducing method is the same as the one described with respect to step S105. In this case, the global model is reduced for each of the edge devices 101.

The global model reduction unit 114 of the server device 100 transmits the reduced global model to each of the edge devices 101 (step S206).

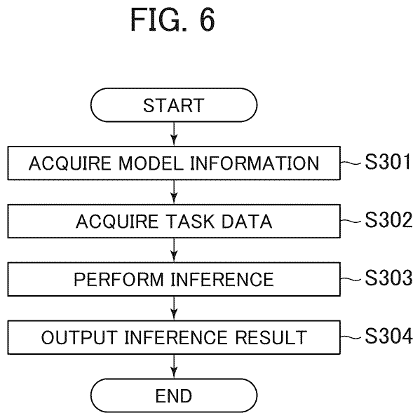

The inference process to be executed by the edge device 101 is described. FIG. 6 is a flowchart representing an example of an inference process to be executed by the edge device 101 according to the first embodiment.

The inference unit 124 acquires information of the model generated by the learning unit 122 (step S301), and acquires task data (step S302).

The inference unit 124 performs inference using the model and the task data (step S303), and outputs the inference result (step S304). Specifically, the inference unit 124 acquires the inference result by inputting the task data into the model.

The computing system may be configured to reduce at least any one of the local model or the global model. It is possible to impart the function of the communication path monitoring device 102 to at least one of the server device 100 or the edge device 101.

Specific cases of the computing system as described in the first embodiment are described below.

### (Case 1) Factory Power Consumption Monitoring and Controlling System

The edge device 101 is communicably connected to the equipment and sensors, which are operated in the factory. The edge device 101 holds a feature extraction model which outputs the feature vector indicating the feature of the power consumption condition based on the data acquired from the equipment and sensors, and a task inference model which outputs a predicted power consumption value or a control policy for reducing the power consumption value using the feature vector.

### (Case 2) System for Controlling Assignment of Product Manufacturing Operation in Factory

The edge device 101 is communicably connected to the equipment and sensors, which are operated in the factory. The edge device 101 holds the feature extraction model which outputs the feature vector indicating the feature of the equipment operation based on the data acquired from the equipment and sensors, and the task inference model which outputs a policy for assigning operations to be performed by robots using the feature vector.

### (Case 3) System for Controlling Manufacturing Operations in Factory

The edge device 101 is communicably connected to the equipment and sensors, which are operated in the factory. The edge device 101 holds the feature extraction model which outputs the feature vector indicating the state of the operation (for example, power of the robot arm to grip the work, and the like) performed by the equipment based on data acquired from the equipment and sensors, and the task inference model which outputs a control value of the equipment using the feature vector.

### (Case 4) System for Monitoring Abnormality in Factory Facility

The edge device 101 is communicably connected to the facility and sensors operated in the factory. The edge device 101 holds the feature extraction model which outputs the feature vector indicating the facility operation state based on data acquired from the facility and sensors, and the task inference model which outputs absence/presence of abnormality in the facility, and contents of the abnormality using the feature vector.

### (Case 5) System for Outputting Cause of Abnormality in Factory Facility

The edge device 101 is communicably connected to the facility and sensors operated in the factory. The edge device 101 holds the feature extraction model which outputs the feature vector indicating the state where the facility abnormality has occurred (for example, presence/absence of electrical noise, abnormality in the rotational speed of the movable part, and the like) based on data acquired from the facility and sensors, and the task inference model which outputs the cause of the facility abnormality using the feature vector.

### (Case 6) Product Quality Management System in Factory

The edge device 101 is communicably connected to the facility and sensors for inspection in the factory. The edge device 101 holds the feature extraction model which outputs the feature vector indicating the product state based on data acquired from the facility and the sensors, and the task inference model which outputs the product quality using the feature vector.

### (Case 7) System for Managing Communication Quality of Communication Network

The edge device 101 is communicably connected to the communication equipment, for example, a transmitter-receiver/node equipment, or the sensor provided for the communication equipment in the optical and radio communication network. The edge device 101 holds the feature extraction model which outputs the feature vector indicating the state of the communication equipment or the communication path connected to the communication equipment, and the task inference model which outputs quality of the communication equipment or the communication path connected to the communication equipment using the feature vector.

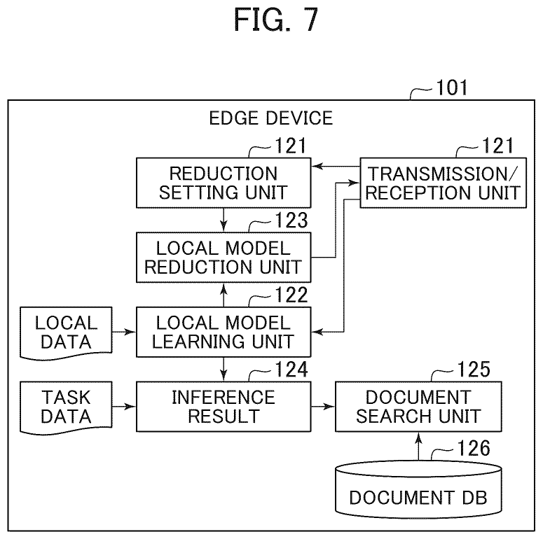

(Modification) The edge device 101 may be configured to execute the process using the inference result. For example, the edge device may be functionally configured as illustrated in FIG. 7. The edge device 101 holds a document DB 126 which stores data associated with the document and the search key, and has a document search unit 125 which searches the document from the document DB 126. The inference unit 124 outputs an estimation key from the task data including images and documents. The document search unit 125 calculates the score for evaluating a similarity value indicative of similarity between the estimation key output from the inference unit 124 and the search key registered in the document DB 126, and searches the relevant document based on the score.

The document DB 126 may be configured to register data for associating the search key indicating the equipment operation state with the document on which solution methods or improvement measures in accordance with the equipment operation state are described. In this case, the inference unit 124 outputs the inference key indicating the equipment operation state based on the task data which contain the value relating to the equipment operation. The document search unit 125 outputs the relevant document. This makes it possible to acquire the equipment-related information.

As described above, the present invention allows reduction of the model in accordance with the communication condition in the federated learning, and transmission/reception of the model between the server device 100 and the edge device 101. This makes it possible to suppress the communication load in the federated learning.

The present invention which is not limited to the aforementioned embodiments includes various modifications. For example, the aforementioned embodiments have been described in detail for easy understanding of the present invention. Therefore, it is not necessarily limited to be configured to have all the structures as described above. It is further possible to add, remove, and replace the other structure to, from and with a part of the structure of the respective embodiments.

Typical aspects of the invention other than those described in the claims are described as below.

(1) In the server device connected to the edge device which acquires data to be used for learning, and executes the learning process to generate the first model to be used for inference relating to the task using the data,
the server device: generates the second model using the first model generated by each of the plural edge devices;
acquires communication state information relating to the communication state of the communication path between the edge device and the server device;
calculates the parameter to be used for the reduction process to reduce the data size of the model based on the communication state information;
executes the reduction process to the generated second model based on the parameter; and
transmits the second model subjected to the reduction process to the edge device.

(2) In the server device according to the aspect (1),
the first model and the second model are neural networks, and
the server device determines a weight of the second model based on an algorithm considering the average value, the mode, and the maximum value of the weight of the first model received from each of the plural edge devices.

(3) In the server device according to the aspect (1),
the edge device generates the feature extraction model which extracts the feature information from the data, and the task inference model which performs the inference relating to the task using the feature information in the learning process, and
the first model is the feature extraction model.

The respective structures, functions, processing units, processing means, and the like may be implemented through hardware by designing those elements partially or entirely using the integrated circuit, for example. The respective functions of the embodiments of the present invention may also be implemented through the program code of software. In this case, the computer is provided with the storage medium having the program codes recorded therein so that the processor of the computer reads the program code stored in the storage medium. In this case, the program code itself read from the storage medium serves to implement functions of the foregoing embodiments. Accordingly, the program code itself and the storage medium that stores such code form the present invention. The storage medium for providing the program code includes, for example, the flexible disc, CD-ROM, DVD-ROM, hard disk, SSD (Solid State Drive), optical disc, magneto-optical disk, CD-R, magnetic tape, non-volatile memory card, and ROM.

The program code that implements functions as specified in the embodiments may be installed through the wide-range program or the script language, for example, the assembler, C/C++, perl, Shell, PHP, Python, and Java®.

The program codes of the software for implementing functions of the embodiments are distributed via the network so as to be stored in the storage means such as hard disk and memory of the computer, or the storage medium such as CD-RW, and CD-R. The processor of the computer may be configured to read the program codes stored in the storage means and the storage medium, and execute the process.

The control line and information line considered as necessary for explanations are shown in the embodiments. They do not necessarily represent all the control and information lines for the product. All the structures may be mutually connected one another.

1. A computing system comprising:
an edge device which acquires data to be used for learning, and executes a learning process to generate a first model to be used for inference relating to a task using the data; and
a server device which generates a second model using the first model generated by each of the plural edge devices, and transmits the second model to the plural edge devices,
wherein the edge device:
acquires communication state information relating to a communication state of a communication path between the edge device and the server device;
calculates a first parameter to be used for a reduction process to reduce a data size of a model based on the communication state information;
executes the reduction process to the generated first model based on the first parameter; and
transmits the first model subjected to the reduction process to the server device.

2. The computing system according to claim 1,
wherein the server device:
acquires the communication state information;
calculates a second parameter to be used for the reduction process based on the communication state information;
executes the reduction process to the generated second model based on the second parameter; and
transmits the second model subjected to the reduction process to the edge device.

3. The computing system according to claim 2,
wherein the first model and the second model are neural networks, and
the server device determines a weight of the second model based on an algorithm considering an average value, a mode, and a maximum value of a weight of the first model received from each of the plural edge devices.

4. The computing system according to claim 1,
wherein the edge device
generates a feature extraction model which extracts feature information from the data, and a task inference model which performs inference relating to the task using the feature information in the learning process, and
the first model is the feature extraction model.

5. A learning method to be implemented in a computing system,
the computing system including: an edge device which acquires data to be used for learning, and executes a learning process to generate a first model to be used for inference relating to a task using the data; and a server device which generates a second model using the first model generated by each of the plural edge devices, and transmits the second model to the plural edge devices,
the learning method comprising:
a first step in which the edge device acquires communication state information relating to a communication state of a communication path between the edge device and the server device;
a second step in which the edge device calculates a first parameter to be used for a reduction process to reduce a data size of a model based on the communication state information;
a third step in which the edge device executes the reduction process to the generated first model based on the first parameter; and
a fourth step in which the edge device transmits the first model subjected to the reduction process to the server device.

6. The learning method according to claim 5, further comprising:
a step in which the server device acquires the communication state information;
a step in which the server device calculates a second parameter to be used for the reduction process based on the communication state information;
a step in which the server device executes the reduction process to the generated second model based on the second parameter; and
a step in which the server device transmits the second model subjected to the reduction process to the edge device.

7. The learning method according to claim 6,
wherein the first model and the second model are neural networks, and
the learning method further includes a step in which the server device determines a weight of the second model based on an algorithm considering an average value, a mode, and a maximum value of a weight of the first model received from each of the plural edge devices.

8. The learning method according to claim 5, further comprising
a step in which the edge device generates a feature extraction model which extracts feature information from the data, and a task inference model which performs inference relating to the task using the feature information,
wherein the first model is the feature extraction model.

9. An edge device which acquires data to be used for learning, and executes a learning process to generate a first model to be used for inference relating to a task using the data,
the edge device including a processor, a memory connected to the processor, and a network interface to be connected to the processor,
wherein the edge device
generates a second model using the first model generated by each of the plural edge devices, and is connected to a server device for transmitting the second model to the plural edge devices,
acquires communication state information relating to a communication state of a communication path between the edge device and the server device,
calculates a parameter to be used for a reduction process to reduce a data size of a model based on the communication state information,
executes the reduction process to the generated first model based on the parameter, and
transmits the first model subjected to the reduction process to the server device.

10. The edge device according to claim 9,
wherein the edge device generates a feature extraction model which extracts feature information from the data, and a task inference model which performs inference relating to the task using the feature information in the learning process, and
the first model is the feature extraction model.
